(19) United States
(12) Patent Application Publication
(10) Pub. No.: US 2009/0298564 A1
(43) Pub. Date: Dec. 3, 2009

(54) METHOD OF PROVIDING SPORT SHOW ON TELEVISION

(76) Inventor: Conroy Walker, Jamaica, NY (US)

Correspondence Address: JAY M. SCHLOFF, 6960 Orchard Lake Road, Suite 315, West Bloomfield, MI, 48322, US

(21) Appl. No.: 12/131,451

(22) Filed: Jun. 2, 2008

(51) Int. Cl. A63F 13/00

(52) U.S. Cl. 463/7; 463/40

(57) ABSTRACT

Disclosed is a method for providing a sport show on a television for entertainment of sports enthusiasts. The sport show comprises a plurality of teams, a plurality of judges and a plurality of spectators. Each team of the plurality of teams comprises a plurality of players. Each player of the plurality of players exhibits a sport skill. The sport show is broadcast on the television for television viewers. The plurality of judges, the plurality of spectators and the television viewers watch each player of the plurality of players exhibiting the sport skill for providing a rating to the sport skill of each player. Score of each player is calculated based on a rating of judges, a rating of spectators and a rating of television viewers and a result of the sport show is declared based on a score earned by each team of the plurality of teams.

### FIELD OF THE INVENTION

The present invention relates generally to an entertainment show, and, more particularly, to a sport show on a television for entertainment of sports enthusiasts.

### BACKGROUND OF THE INVENTION

In today's world, television may be considered as one of the main sources that provides entertainment to people. With an increasing use of television, broadcasters have started screening a variety of reality shows featuring a variety of themes. For example, based on the interest of television viewers, broadcasters have started screening reality shows, which generally relate to themes focusing on dancing skills of participants, singing skills of the participants, and the like.

Such types of reality shows typically include a plurality of participants exhibiting skills, such as singing or dancing. Each participant of the plurality of participants may be given a score for a performance based on the skills exhibited. These reality shows often declare results of the performances depending upon the score earned by each participant. For example, one participant among the plurality of participants may be declared as a winner of a reality show for a skill. Although such reality shows provide entertainment to a large number of television viewers, there exist a category of the television viewers such as sports enthusiasts who do not enjoy such reality shows to a great extent. Moreover, apart from matches shown on sports channels, there are a limited number of sport shows broadcasted on the television that are specially designed for the entertainment of sports enthusiasts. Further, the sport shows broadcasted on the television do not concentrate on improving the sport skills of the players participating in the sport show.

Accordingly, there exists a need for a sport show broadcasted on a television for entertainment of sports enthusiasts. Additionally, there also exists need for a sport show that enables players participating in the sport show and people watching the sport show to improve their sport skills.

### SUMMARY OF THE INVENTION

In view of the foregoing disadvantages inherent in the prior art, the general purpose of the present invention is to provide a sport show on a television configured to include all the advantages of the prior art, and to overcome the drawbacks inherent therein.

Accordingly, an object of the present invention is to provide a sport show on television for entertainment of sport enthusiasts.

Another object of the present invention is to provide a sport show on television that enables in improving sport skills of a plurality of players participating in the sport show and television viewers watching the sport show.

In light of the above objects, in one aspect of the present invention, a method for providing a sport show on a television is disclosed. The method comprises organizing the sport show, broadcasting the sport show, calculating a score and declaring a result of the sport show. The sport show comprises a plurality of teams, a plurality of judges and a plurality of spectators. Each team of the plurality of teams comprises a plurality of players. Each player of the plurality of players exhibits a sport skill based on a predefined set of rules of the sport show. The plurality of judges watches each player of the plurality of players of the plurality of teams exhibiting the sport skills for providing a rating to the sport skill exhibited by each player of the plurality of players of the plurality of teams based on a set of show criteria. The plurality of spectators watches each player of the plurality of players exhibiting the sport skill for providing a rating to the sport skill performed by each player of the plurality of players based on the set of show criteria.

The sport show is broadcast on the television for television viewers. The television viewers watch each player of the plurality of players exhibiting the sport skills for providing a rating to the sport skill performed by each player of the plurality of players based on the set of show criteria. A score is calculated for each team of the plurality of teams based on the rating of judges, the rating of spectators and the rating of television viewers and from a predefined weight for each of the rating of judges, the rating of spectators and the rating of television viewers. A result is declared for the sport show based on the score calculated for each team of the plurality of teams.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWING

The advantages and features of the present invention will become better understood with reference to the following detailed description and claims taken in conjunction with the accompanying drawing, in which:

FIG. 1 illustrates a schematic representation of a sport show to be organized and broadcast on a television, in accordance with an exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a sport show on a television, as shown and described. It is understood that various omissions and substitutions of equivalents are contemplated as circumstances may suggest or render expedient, but these are intended to cover the application or implementation without departing from the spirit or scope of the claims of the present invention.

The terms “a” and “an” herein do not denote a limitation of quantity, but rather denote the presence of at least one of the referenced item.

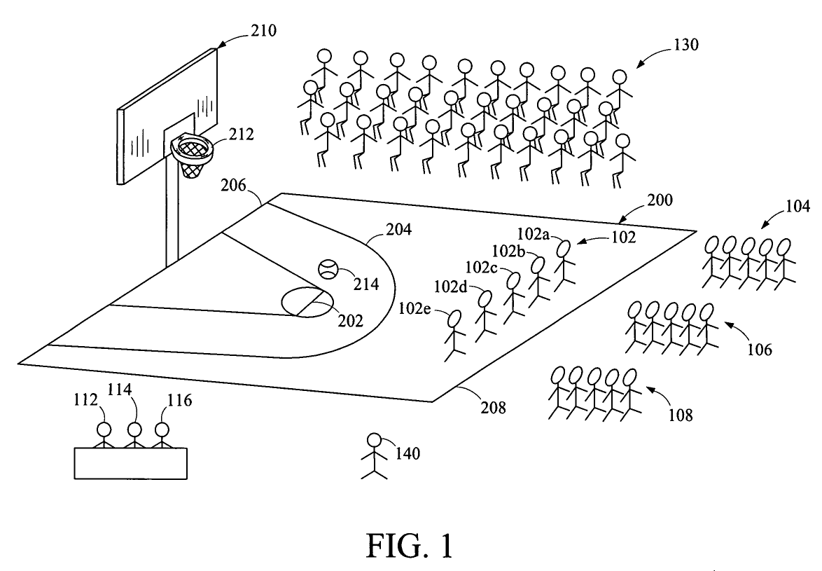

The present invention provides a sport show on a television for entertainment of sports enthusiasts. More specifically, the present invention provides a method for providing a sport show on the television for the entertainment of the sports enthusiasts. Referring to FIG. 1, illustrated is a schematic representation of the sport show, in accordance with an exemplary embodiment of the present invention. The sport show includes a plurality of teams including a team 102, a team 104, a team 106 and a team 108 (hereinafter the plurality of teams are collectively referred to as ‘teams’), a plurality of judges including a judge 112, a judge 114 and a judge 116 (hereinafter the plurality of judges are collectively referred to as ‘judges’) and a plurality of spectators 130.

In the embodiment shown in FIG. 1 of the present invention, the sport show includes only four teams. However, it will be obvious the person skilled in the art that the sport show may also include greater or fewer number of teams. The teams may be featured with different names and uniforms in order to distinguish one team from another team. For example, the team 102 may be named as red team, the team 104 may be named as blue team, the team 106 may be named as green team and the team 108 may be named as gray team.

Each of the teams includes a plurality of players. In the embodiment of the present invention as shown in FIG. 1, the team 102 includes five players, such as a player 102a, a player 102b, a player 102c, a player 102d and a player 102e (hereinafter collectively referred to as ‘players 102a-e’). However, it will be obvious to a person skilled in the art that the representation of only five players in the team 102 is for the exemplary purposes only, and it should not be considered limiting. Further, other teams, such as the team 104, the team 106 and the team 108 may also include five players each. The sport show further includes at least one host, such as a host 140 for conducting the sport show.

Each player, such as the player 102a-e of the team 102 performs a sport skill. In a preferred embodiment of the present invention, the sport skill may be related to a sport of basketball. More specifically, each player of the team 102 performs the sport skill, such as a free throw from a free-throw line on a basketball court. The term ‘free throw’ used herein refers to a skill in which a player is allowed to toss a basketball into a basketball ring from the free-throw line, without interruption by a plurality of opponent teams.

Referring again to FIG. 1, further illustrated is an exemplary basketball court 200 having standard markings, such as a free-throw line 202, a three-point line 204, an end line 206, a half-court line 208. Also illustrates are other components required in basketball that includes a backboard 210 with a basketball ring 212 and a ball 214. In the present embodiment, each player of the team 102 takes the free throw from the free-throw line 202 for showing his capability of converting the free throw into a basket (goal).

The each player of the team 102 performs the sport skill based on a predefined set of rules of the sport show. For example, in one embodiment of the present invention each player of the team 102 is allowed to take ten free throws from the free-throw line 202 in a consecutive manner. More specifically, the player 102a takes ten consecutive free throws from the free-throw line 202 and, thereafter, each of the players 102b, 102c, 102d and 102e may consecutively take ten free throws. Once each member of the team 102 completes the free throws, each player of the plurality of players of opponent teams, such as the team 104, the team 106 and the teamlO8 may take ten free throws from the free-throw line 202. However, it will be apparent to person skilled in the art that the number of free throws may also be any number greater or fewer than ten based on the predefined set of rules of the sport show.

The predefined set of rules may include rules, such as a player earns one point on a successful free throw. The successful free throw may be defined as a throw in which the ball 214 is shot such that the ball passes through the basketball ring 212. Further, zero or negative points may be awarded to the player upon failing to shoot the ball 214 in the basketball ring 212. Furthermore, the predefined set of rules may also include rules, such as stepping on the free-throw line 202 by the player while taking the free throw may be considered as foul and the free throw may be cancelled. Moreover, the player may not be allowed to lift his/her toe portion from the basketball court 200 while taking the free throws.

The judges watch performance of each of the teams to provide a rating to the sport skill performed by each player of the plurality of players of each of the teams. The judges may consider the points earned by the each player of a team while exhibiting the sport skill in providing the rating to the sport skill of the each player. The judges may provide an individual rating to each player of a team. The rating of the team may be calculated by summing the individual rating of each players of the team, obtained from the judges. In one embodiment of the present invention the sport show includes three judges for the purpose of illustration. However, it will be obvious to a person skilled in the art that the sport show may also include greater or fewer number of judges.

The judges may provide a rating to a player based on a set of show criteria. The set of show criteria may include a speed of exhibiting a free throw, a number of consecutive successful free throws and an overall performance of the player. The term ‘speed of exhibiting the free throws’ used herein refers to a time taken by the player to complete throwing all free throws allowed to the player, such as a time taken in completing ten free throws. Further, for consecutive successful free throws by the player, score earned by the player may be comparatively more than a score that the player may earn for random successful free throws. Additionally, the overall performance of the player may be based on the number of successful consecutive free throws without committing any foul.

In one embodiment of the present invention, the rating provided by the judges to the sport skill performed by each player may be displayed on an electronic scoreboard. The electronic scoreboard may be used for showing a score earned by each player of each of the teams upon completion of the performance of the sport skill by each of the teams. More specifically, each of the judges may have access to an electronic pad for rating the sport skill of the each player of the teams, which is displayed on the electronic scoreboard.

The plurality of spectators 130 also watches each of the teams exhibiting the sport skill. In one embodiment of the present invention, the spectators 130 provide a rating to the sport skill performed by each player of the plurality of players of the teams. More specifically, the spectators 130 may also have access to electronic pads, similar to the electronic pads accessed by the judges for rating the sport skill of the each player. Further, the rating of the sport skill provided by the spectators 130 may be based on the set of show criteria.

The sport show explained above is broadcast on televisions for the entertainment of the television viewers. The television viewers may watch the teams exhibiting the sport skill. In one embodiment of the present invention, the television viewers may be capable of providing a rating to the sport skill performed by each player of the teams. More specifically, the television viewers may provide the rating to the sport skill performed by each player by using their mobile phone, such as by a short message service or calling given numbers. Furthermore, the rating of the sport skill provided by the television viewers may be based on the set of show criteria.

The sport show of the present invention may be divided into a number of episodes. More specifically, based on scores earned by each of the teams, a team may be eliminated or retained in the sport show in an episode. Further, in one embodiment of the present invention, a score earned by a player may be calculated based on the rating provided by the judges and the rating provided by the spectators 130 to the player. Furthermore, the rating provided by the television viewers to the player may also be used to calculate the score of the player.

However, in one embodiment of the present invention, the score of the player may be calculated by considering a predefined weight assigned to each of the rating of the judges, the rating of the spectators 130 and the rating of the television viewers. More specifically, in a preferred embodiment, the rating of the judges includes more weight as compared to the rating of the spectators 130 and the television viewers. In this embodiment, the score of the player may be calculated by summing a product of the rating provided by the judges and a predefined weights assigned to the rating provided by the judges, a product of the rating provided by the spectators 130 and predefined weight assigned to the rating provided by the spectators 130, and a product of the rating provided by the television viewers and predefined weight assigned to the rating provided by the television viewers. Similarly, the score of a team may be calculated based on the summation of scores of each player of the team. Therefore, a team having least score among the teams 102, 104, 106 and 108, may be eliminated in an episode of the television game show.

Each of the episodes of the sport show may be of a predefined time duration. It will be obvious to person skilled in the art that the predefined time duration of an episode may depend upon the numbers of teams participating in the sport show and numbers of players included in each of the teams. Further, a team or a player from the teams may be declared as a wining team or a wining player based on a highest score earned by the team or the player in a final episode of the sport show. Finally, the wining team and/or the wining player may be awarded prizes, such as a trophy or money.

The sport show, as described herein, enables in determining a player having most number of successful free throws. Specifically, the sport show enables finding a most skilled free throw shooter among all the players. The sport show of the present invention may be divided into different levels based on age groups, for example, high school level, college level, and the like. Further, the sport show may feature other sports apart from basketball, such as football, hockey, and the like. The sport show may further enable in improving sport skills of a plurality of players participating in the sport show and television viewers watching the sport show.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. A method for providing a sport show on a television, the method comprising:
organizing the sport show, the sport show comprising
a plurality of teams, each team of the plurality of teams comprising a plurality of players, each player of the plurality of players exhibiting a sport skill based on a predefined set of rules of the sport show,
a plurality of judges watching each player of the plurality of players of the plurality of teams exhibiting the sport skill for providing a rating to the sport skill performed by each player of the plurality of players based on a set of show criteria, and
a plurality of spectators watching each player of the plurality of players exhibiting the sport skill for providing a rating to the sport skill performed by each player of the plurality of players based on the set of show criteria;
broadcasting the sport show on the television for television viewers, the television viewers watching each player of the plurality of players exhibiting the sport skill for providing a rating to the sport skill performed by each player of the plurality of players based on the set of show criteria;
calculating a score of each team of the plurality of teams based on the rating provided by the plurality of judges, the rating provided by the plurality of spectators, the rating provided by the television viewers, and a predefined weight assigned to the rating provided by the plurality of judges, a predefined weight assigned to the rating provided by the plurality of spectators and a predefined weight assigned to the rating provided by the television viewers; and
declaring a result of the sport show based on the score of each team of the plurality of teams.

2. The method of claim 1, wherein organizing the sport show further comprises conducting the sport show, the sport show conducted by at least one host.

3. The method of claim 1, wherein exhibiting the sport skill comprises exhibiting a free throw from a free-throw line in basketball.

4. The method of claim 3, wherein the set of show criteria comprises a speed of exhibiting the free throw, a number of consecutive successful free throws and an overall performance of each player of the plurality of players.

5. The method of claim 1, wherein declaring the result comprises eliminating a team from the plurality of teams scoring a least score among scores of the plurality of teams.

6. The method of claim 1, wherein declaring the result comprises selecting a team as a wining team from the plurality of teams, the wining team scoring a highest score among scores of the plurality of teams.

7. The method of claim 6, wherein declaring the result further comprises selecting a player as a wining player from the wining team scoring the highest score.
